(19) United States
(12) Patent Application Publication
(10) Pub. No.: US 2024/0068298 A1
(43) Pub. Date: Feb. 29, 2024

(54) AUTOMATED WINDOW COVERINGS FOR WINDOWS

(71) Applicants: Advik Lalam, Munster, IN (US); Ajitesh Lalam, Munster, IN (US); Sree Harsha Lalam, Munster, IN (US)

(72) Inventors: Advik Lalam, Munster, IN (US); Ajitesh Lalam, Munster, IN (US); Sree Harsha Lalam, Munster, IN (US)

(21) Appl. No.: 18/446,019

(22) Filed: Aug. 8, 2023

Related U.S. Application Data
(60) Provisional application No. 63/370,745, filed on Aug. 8, 2022.

(51) Int. Cl. E06B 9/38; E06B 9/262

(52) U.S. Cl. CPC E06B 9/38; E06B 9/262; E06B 2009/2488; E06B 2009/2625

(57) ABSTRACT

Automated systems and methods that use wireless technologies to control the extent to which windows are covered with window coverings based on temperatures or light intensities. Such a system preferably includes a window unit having a window covering sized and configured to at least partially cover the window when the window covering is in a deployed configuration thereof and expose the window when the window covering is in a stowed configuration thereof. The window unit further has a base mountable to a frame of the window, a motor supported on the base, an arm assembly associated with the motor and connected to the window covering so that the motor is operable to rotate the window covering, and a base guide mounted to the base and configured to guide the movement of the window covering as the window covering rotates between the deployed and stowed configurations thereof.

### CROSS-REFERENCE TO RELATED APPLICATIONS

This application claims the benefit of U.S. Provisional Application No. 63/370,745 filed Aug. 8, 2022, the contents of which are incorporated herein by reference.

### BACKGROUND OF THE INVENTION

The present invention generally relates to window coverings and their operation. The invention particularly relates to automated systems and methods using wireless technologies to control the extent to which windows are covered with window coverings based on temperatures or light intensities.

Currently, there are commercially available window coverings that are operated manually by using Web-based interfaces and are not automatically controlled based on temperature or light intensity. The interfaces simply have open and close functionality, and are not integrated with environmental factors like light intensity (brightness), temperature, sunrise, sunset, and user privacy. Moreover, these products are only manually controlled up and down, not automated. Some window coverings are fixed to a curved window (used herein to denote a window having at least a portion of its perimeter that is arched or otherwise curved) to permanently cover the window opening and are manually operated. Motorized coverings exist for curved windows operating in a vertical configuration with manual remote control. These covers are not integrated with environmental factors, not interfaced with Web control, and not self-controlled devices, and may not work with fully circular windows.

Home automation systems exist that utilize an HVAC (heating, ventilation, and air-conditioning) sub-system to use a host computer to transmit messages through different nodes of the system and reach individual devices of the system. However, these systems are network-related rather than being specific to window coverings.

Various patents have addressed window covering communications, powering the devices, and functionality relating to window covering devices, examples of which include U.S. Pat. Nos. 5,621,662, 10,142,122, and 7,719,215, and U.S. Patent Application Publication Nos. 2020/0069100 and 2020/0379422, European Patent EP 1071929, and Canadian Patent Application No. 3,002,247, and Canadian Patent No. 2,547,562. U.S. Pat. No. 7,719,215 discloses a window covering system that uses a single wall switch to control one or more window shades, and U.S. Patent Application Publication No. 2020/0069100 discloses a battery-powered motor capable of driving a shaft to open and close a window blind. European Patent EP 1071929 discloses detection of the position of rotating body, and Canadian Patent Application No. 3,002,247 and Canadian Patent No. 2,547,562 disclose systems for use with motorized window coverings. However, these systems are not automated to respond to environmental conditions. U.S. Patent Application Publication No. 2020/0379422 discloses the use of light sensing modules to open and close rectangular window covering systems. These systems have utilized a light-sensing module to automate the entire window covering system in a building, rather than multiple modules to independently operate individual window coverings.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, automated systems and methods that use wireless technologies to control the extent to which windows are covered with window coverings based on temperatures or light intensities.

According to a nonlimiting aspect of the invention, an automated system is provided for controlling the extent to which a window is covered based on temperatures and/or light intensities at the window. The system includes a window unit having a window covering sized and configured to at least partially cover the window when the window covering is in a deployed configuration thereof and expose the window when the window covering is in a stowed configuration thereof. The window unit further has a base mountable to a frame of the window, a motor supported on the base, an arm assembly associated with the motor and connected to the window covering so that the motor is operable to rotate the window covering, and a base guide mounted to the base and configured to guide the movement of the window covering as the window covering rotates between the deployed and stowed configurations thereof.

Additional nonlimiting aspects of the invention include methods of operating an automated system as described above.

Technical aspects of systems as described above preferably include the capability of providing an integrated automatic rotating window covering system that can be used with curved windows as well as other shapes. The system can accommodate different types of coverings for curved windows ranging from zero to three hundred sixty degrees. Rotation of the window covering can be automatically controlled by environmental factors or by user-specific inputs via wireless and/or wired controls. The system can further utilize a microcontroller that can tailor the operation of the system based on various operational factors, including but not limited to temperature, light intensity (brightness), sunrise and sunset times, as well as user-operated controls. The system preferably enables a user to prefer a specific environmental condition (e.g., temperature or brightness at a window) and operate the window covering accordingly. Throughout the day, based on brightness, internal temperature, and external temperature, the window covering can assist in maintaining user-specified conditions within a room in which the window and window covering are installed. In certain embodiments, temperature and brightness settings can be overridden by sunset time to increase the privacy, wherein the window covering is automatically closed or opened based on user preference. Programed priorities may be superseded by a user's selection until sunrise, which allows the user to open and close the window coverings to their preferred angle of opening. User preferences and manual control features may be selectable through a user interface (e.g., a computer or mobile device). Once the user sets their parameters of interest, the system is preferably capable of functioning automatically throughout the day and assist in conserving energy. The window covering can have an aesthetically pleasing design and also accept images projected onto the covering.

Other aspects and advantages will be appreciated from the following detailed description as well as any drawings.

### BRIEF DESCRIPTION OF THE SEVERAL VIEWS OF THE DRAWING

FIGS. 1 and 2 schematically represent, respectively, expanded (deployed) and collapsed (stowed) configurations of a window unit in accordance with a nonlimiting embodiment of this invention.

FIGS. 3 and 4 schematically represent details of components of the window unit of FIGS. 1 and 2.

FIG. 5 schematically represents a stiffener assembly capable of use with the window unit of FIGS. 1 and 2.

FIG. 6 schematically represents a support assembly capable of use with the window unit of FIGS. 1 and 2, and FIG. 7 schematically represents a window covering installed on the support assembly.

FIG. 8 depicts a main flow diagram of a system for automatically controlling the window unit of FIGS. 1 and 2.

FIG. 9 depicts a process flow diagram of the system for automatically controlling the window unit of FIGS. 1 and 2.

FIG. 10 depicts a visualization of the functionality of the system and exemplary screens displayed on a Web page for automatically controlling the window unit of FIGS. 1 and 2.

FIG. 11 depicts user preferences that can be selected and input by a user for automatically controlling the window unit of FIGS. 1 and 2.

FIG. 12 depicts visualizations of sunrise/sunset, brightness, and custom functionalities of the system for controlling the window unit of FIGS. 1 and 2.

FIG. 13 depicts data collected between sunrise and sunset from a window unit of FIGS. 1 and 2 on a window having a 180-degree arch with light intensity as a priority over temperature.

### DETAILED DESCRIPTION OF THE INVENTION

The intended purpose of the following detailed description of the invention and the phraseology and terminology employed therein is to describe [what is shown in the drawings, which include the depiction of and/or relate to] one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

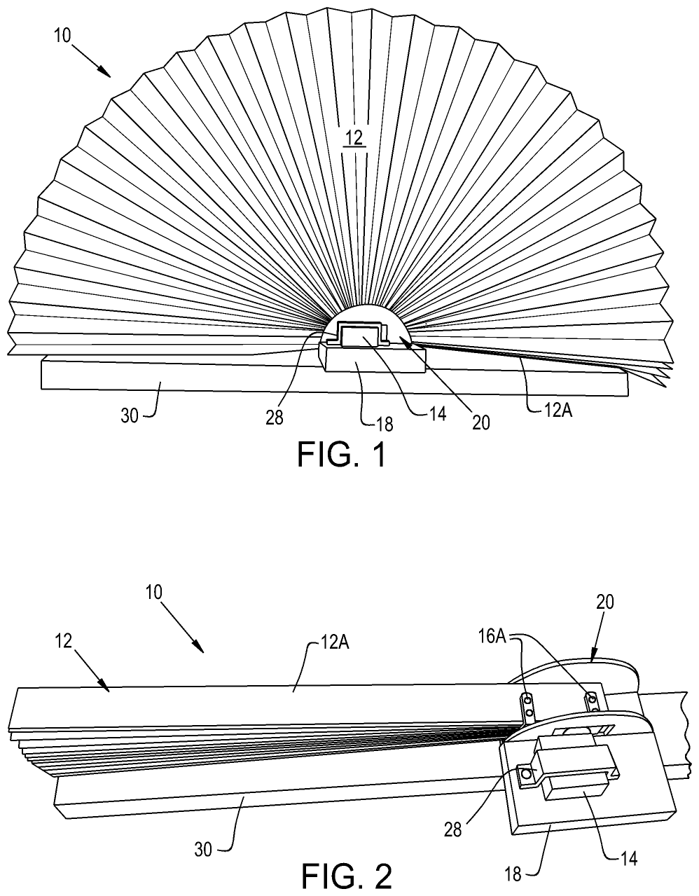

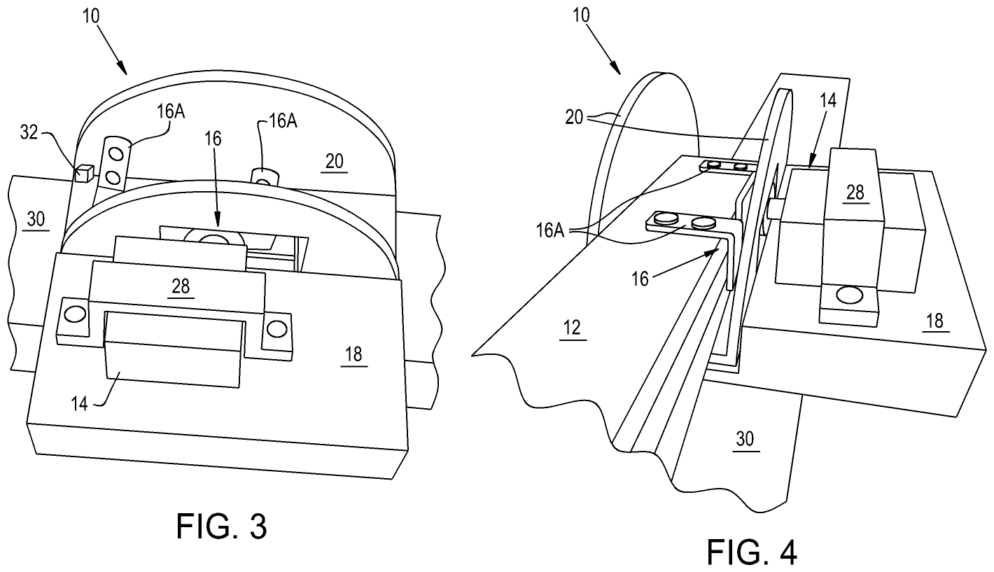

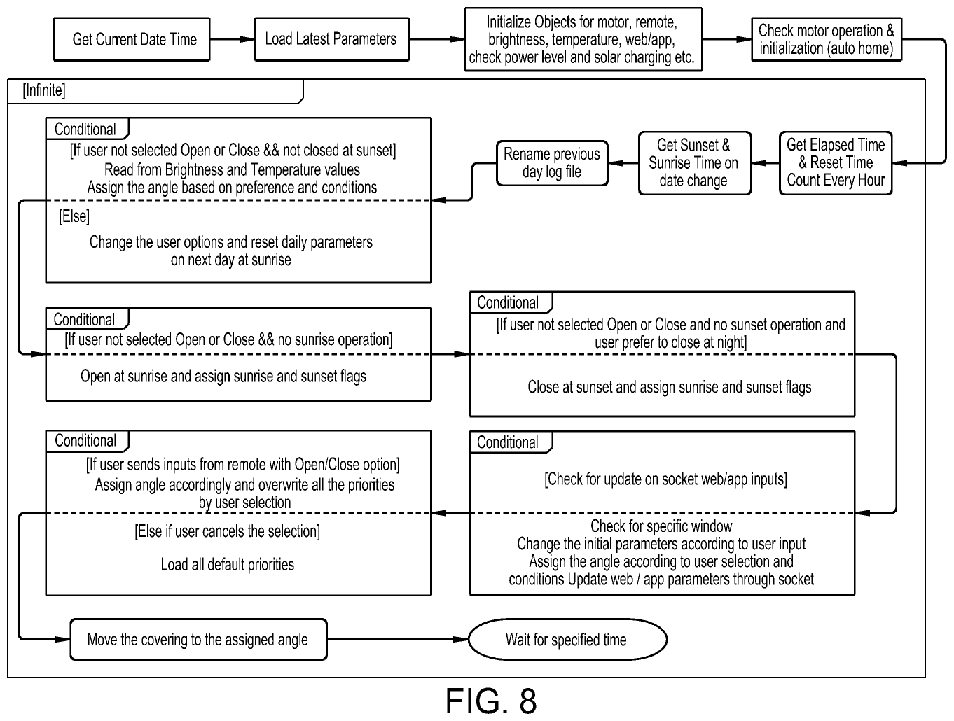

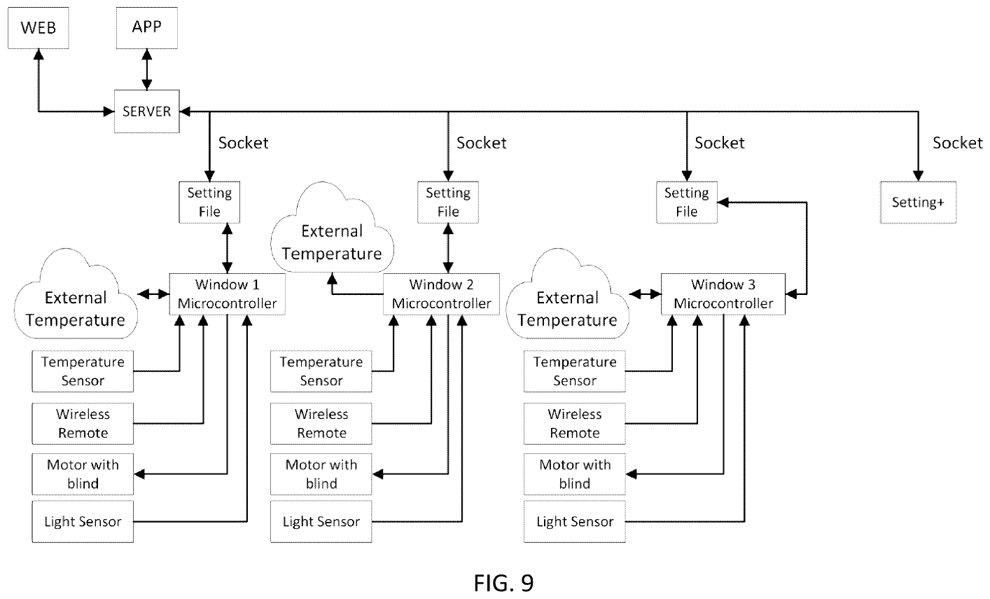

The drawings schematically represent automated systems and methods using wireless technologies to control the extent to which a window may be covered with window coverings 12 (sometimes referred to as a blinds) based on temperature, light intensities, time of day, and user preferences. Such a system is capable of use to cover curved windows, including arched, semicircular, and circular windows, as well as non-curved windows such as rectangular and square windows. The nonlimiting embodiments represented in the drawings are for installations on curved windows. The system comprises a window unit 10 (represented in FIGS. 1 through 7), a control system (whose functionalities are represented in FIGS. 8 through 12) comprising sensors (e.g., temperature, light, and/or position sensors), and one or more interactive user interfaces (e.g., “wireless remote” in FIG. 9). The system preferably utilizes an individual window unit 10 for each window to be controlled with the system. The window unit 10 comprises a window covering 12, a motor 14 equipped with an arm assembly 16 that is connected to the window covering 12, a base 18 mountable to a window frame 30 and on which the motor 14 is mounted or otherwise supported, and a base guide 20 that guides the movement of the covering 12 between two flanges of the guide 20, as shown in FIGS. 1 through 4. The window covering 12 preferably has at least one radial support member 12A along a radial edge thereof that is adapted to be attached to individual arms 16A of the arm assembly 16. The arms 16A are preferably spaced apart a distance that is sufficient to support the window covering 12 and enable it to move smoothly within the guide 20 and rotate over the entire surface of a window. The radial edge of the covering 12 opposite the radial support member 12A may be secured directly to the window frame 30, such as with double-sided tape or screws so that the covering 12 is able to expand (deploy) as it is rotated with the motor 14 to cover a window (FIG. 1), and then collapse (stow) onto itself during closing until the window is fully exposed (FIGS. 2 and 3). Depending on the shape of the window, the angle over which the window covering 12 can be caused to expand can be changed through user settings, as discussed below. This window covering 12 is preferably externally controlled and powered by a microcontroller connected to a server operating in an intranet, as also discussed below.

FIG. 3 schematically represents the base 18 as being equipped with a position sensor 32 for detecting the position of the window covering 12 within the guide 20 and therefore on the window on which the covering 12 is installed. The position sensor 32 can be initialized by detecting the zero angle of the window covering 12 or the motor 14 when in the fully collapsed position for use as a reference for the system to accurately position the window covering 12 at desired angles.

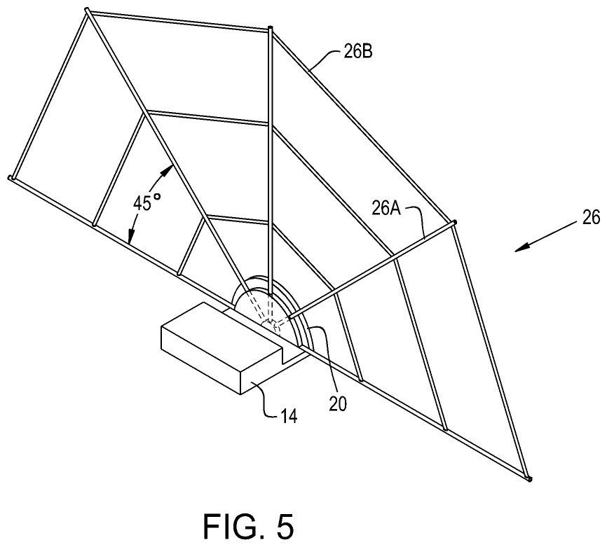

The window unit 10 can utilize a stiffener assembly 26 with radial members 26A and interconnecting members 26B therebetween (FIG. 5) to accommodate various types of coverings 12 and provide additional support for the window covering 12 when installed on larger windows. In FIG. 5, the covering 12 is omitted to better show the positions of the radial members 26A and how they are interconnected with the interconnecting members 26B, which may be flexible threads that can take tension but will collapse under compression. FIG. 5 also represents the radial members 26A as positioned 45 degrees from each other when the covering 12 is fully expanded, though lesser and greater spacings are foreseeable.

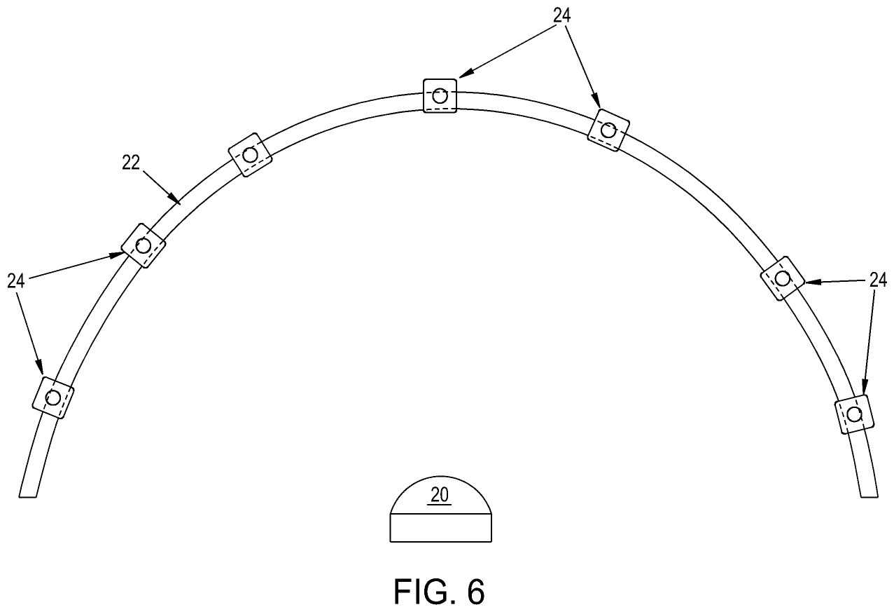

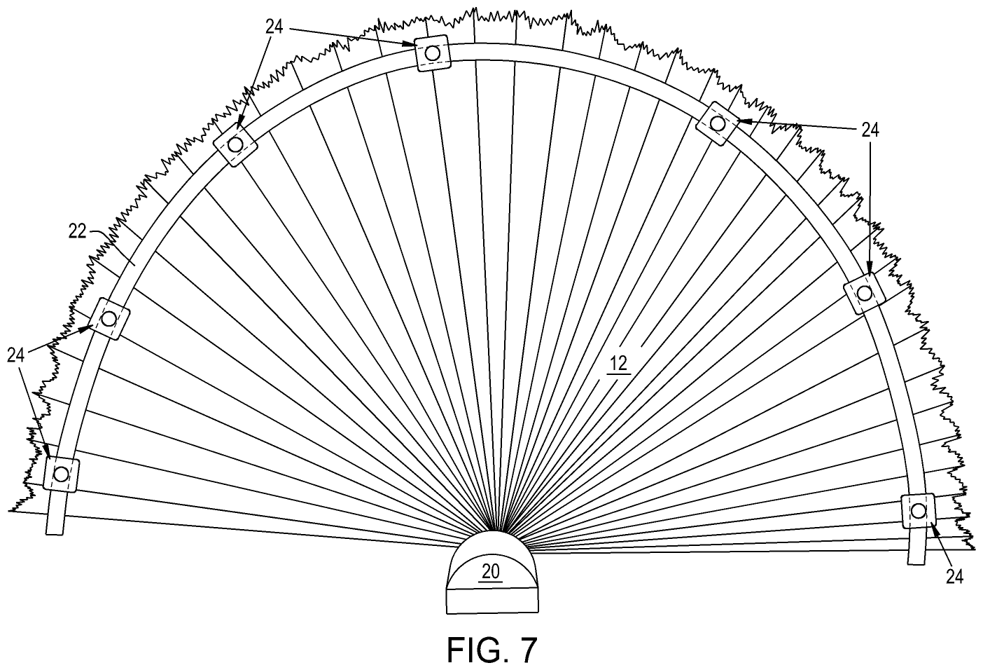

For embodiments in which the coverings 12 are large, i.e., span a relatively large radius of a curved window or relatively large width of a non-curved window, FIGS. 6 and 7 depict the window unit 10 as further utilizing a perimeter support 22 with clip guides 24 that are angular spaced along an outer distal edge of the covering 12 relative to the motor 14 and slidably attached to the support 22. The perimeter support 22 shown in FIGS. 6 and 7 is configured to be mounted along or adjacent an arch of an arch-shaped window. The clip guides 24 may be connected to the radial members 26A if used (FIG. 7), or may be directly attached to the perimeter of the covering 12. In combination, the support 22, clip guides 24, and stiffener assembly 26 can cause the covering 12 to be sufficiently flat and taut to serve as a screen onto which an image can be displayed or projected with an image projector as an optional component of the window unit 10. It is foreseeable that the window covering 12 could be constructed of a sufficiently rigid material to eliminate the need for the support 22, clip guides 24, and/or stiffener assembly 26.

FIG. 9 identifies certain components of the system. Temperature, light, and position sensors are preferably integrated into the system such that, after initial user-specific inputs are made, the system is capable of operating automatically without any further need for user intervention. The system can be controlled with the interactive user interface, such as the wireless remote identified in FIG. 9 but alternatively or additionally a computer or mobile device, through which specific inputs can be given to the system. As it automatically assists to meet user-specific environmental conditions, the system is capable of saving energy utilized to heat and cool of the building. The system may utilize multiple independent modules that work in tandem with multiple window coverings 12 on multiple windows to control the coverings 12 depending on localized environmental conditions at each window to meet potentially different parameters at individual windows. By varying the operations of window coverings 12 in a building based on the different environmental conditions to which the windows are subjected, HVAC systems can be operated more efficiently. The advantage of utilizing the system with windows of a building (e.g., residential or commercial) is that it can be fully integrated and automated to assist atmospheric conditions within the building by reacting to external temperatures, internal temperatures, light intensities (brightness), and sunrise and sunset conditions. The system can also be manually controlled with the interactive user interface to customize the operations of one or more window coverings 12 on a particular day.

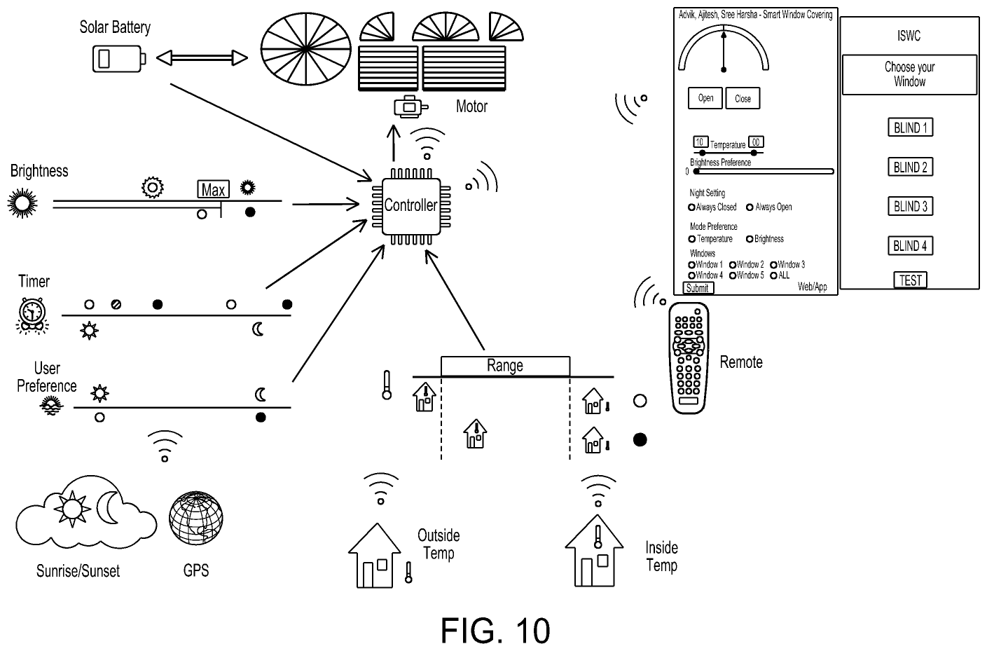

The system is capable of use and installation on windows with various different shapes, including those schematically represented in FIG. 10. FIG. 8 is a flow diagram identifying certain steps that are preferably performed during the initial installation and use of the system. The sensors communicate with a microcontroller (“Microcontroller” in FIG. 9; “Controller” in FIG. 10) of the system, which makes decisions through a series of logical steps represented in FIG. 8. The process begins with the system obtaining the current date and time from the microcontroller, as well as the latest setting parameters stored on the microcontroller for each window to be controlled with the system. The system initializes the motor 14, the interactive user interface, the sensors (“Temperature Sensor” and “Light Sensor” in FIG. 9), and a Web/network socket (“Socket in FIG. 9) for each window to be controlled with the system. The system can also check the power level and voltage of the system if it is powered by batteries or charged with solar panels. After initializing the motor 14 associated with the window covering 12, the system preferably performs an auto-home operation by which the window covering 12 detects a home position thereof with the position sensor 32 installed on the window covering 12 or on the window. Additionally, various settings can be stored on the microcontroller corresponding to different extents to which the covering 12 covers the window, for example, the angular orientation of the arm assembly 16 as the arm assembly 16 is rotated to cover a curved window with the covering 12. Afterwards, by reading previous settings stored on the microcontroller, the covering 12 will go to the last set angle of the window covering 12.

After initializing and retrieving the last set parameters, the infinite process loop starts as shown in FIG. 8. Certain communication steps identified in FIG. 8 are preferably performed with a communication module of the system that obtains local weather from an external source, such as a Web-based source. To save power, the communication module may be scheduled to communicate with the external source every ten minutes, and for this, a counter will be reset every hour. The communication module also preferably contacts an external Web-based source for the local sunrise and sunset time after detecting a date change. Once a date change is detected, the system renames the previous day log file and creates a new log file for the new day. Some users may prefer privacy during night time, and those preferences can be input during in the initial setup. Once the current time matches with the sunrise or sunset time, the system executes the user preference either by opening or closing the window covering 12. The system may control the temperature and light sensors to obtain their respective data at certain intervals, as a nonlimiting example, every three hundred seconds, and only execute the user preference if the change is consistent during the entire interval. This avoids any temporary light intensity or temperature fluctuations due to cloud cover or any local obstructions of the sensors. In addition, any temporary changes made with the interactive user interface (e.g., wirelessly with the wireless remote of FIG. 9) to the initial user setting are preferably reset at the next day's sunrise to ensure that the integrated system will manage the process to implement the initial user preferences. When there is no temporary open-close selection by the user, the system executes the initial user preference at sunrise and sunset and modifies the variables to record the execution to ensure that the system executes sunrise and sunset user preferences if the system loses power during a day.

The process also encompasses detecting any changes to the system settings through a computer or mobile devices connected through the socket, such as a 5007 plug-in electronic component socket. The program reads any new settings for a window covering 12 when it detects a change in the socket cache, for example, a cache size of 1024 bytes. Small cache sizes enable the microcontroller to read and transmit at a faster rate. The system executes only the changes in the settings and communicates to an external server. This server-client network communication through the socket allows parallel programming, decreases communication or interaction with the server, and makes the system more efficient in using resources.

Though initial user settings can be implemented at system initialization, a user may wish to open, close, or partially open or close a window covering 12 for comfort at certain times. Such an input can be achieved through the interactive user interface, e.g., the wireless remote of FIG. 9. The system is equipped with a wireless receiver to read the signal from the wireless remote. The system checks for any signal from the wireless remote and executes a command, as nonlimiting examples, open, close, and reset to default initial settings. After receiving all inputs, the system executes the specified angle desired for the window covering 12 by sending a signal to the motor 14. The system is preferably programmed or programmable to follow certain priorities, for example, from lowest to highest, sunrise-sunset, temperature, light intensity change, Web input change, and user interface input. These priorities can be tailored to increase the priority of user comfort and user input. The system can then go into a sleep mode for a predetermined time delay, e.g., one second, before continuing the loop. This time delay allows for the window covering 12 to be moved to the specified angle before the control loop resumes.

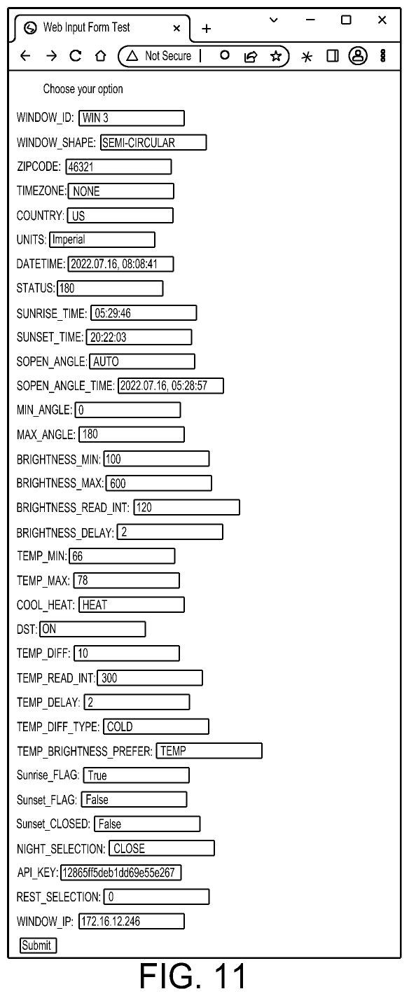

In FIG. 9, the process can be independently initiated by the server and the microcontroller assigned to a particular window. The microcontroller and server communicate through the socket by exchanging the setting file for a particular window. The microcontroller associated with a window independently obtains information from the wireless remote and the temperature, light, and/or position sensors also associated with that window. The microcontroller controls the window covering 12 by transmitting to the motor 14 an angular output signal corresponding to the desired angle for the covering 12. All of the microcontrollers in the system communicate with the server for outside weather information, and each microcontroller preferably independently communicates with the server. The server is preferably capable of independently or collectively controlling each of the microcontrollers. A visualization of the functionality of the integrated system is schematically represented in FIG. 10, in which inputs from both mobile (“remote”) and computer-based (“Web/App”) user interface units are represented for a specific window as well as the entire system of multiple window selection buttons (“Blind1,” etc.). FIG. 11 represents nonlimiting examples of parameters that may be modified and information the user can see for an individual window. Particularly notable parameters are WINDOW_ID, to identify a specific window, STATUS, showing the current angle of the window covering 12 of that window, the light intensity settings through BRIGHTNESS_MIN and BRIGHTNESS_MAX, and the temperature settings through TEMP_MIN and TEMP_MAX. The user can set the priority between temperature and light intensity through TEMP BRIGHTNESS PREFER. The user can set the privacy during night through NIGHT_SELECTION. FIG. 12 represents examples of logical steps for inputting settings for sunrise, sunset, light intensity, and a user-programmable schedule. The settings, as specified in FIG. 11, can be implemented during sunset, sunrise, light intensity changes, and temperature changes according to the user setting. These flexible user inputs and automatic rotating window coverings 12, reacting to environmental conditions, promote energy savings and user comfort.

Various configurations, performance parameters, and dimensions are foreseeable for the various components of the system, and the examples represented in the drawings are intended as nonlimiting examples. For example, the guide 20 may be fabricated as a unitary component with the base 14 or fabricated as a detachable component to enable the guide 20 to be tailored for the particular size, stiffness, and type of window covering 12. For example, a larger guide 20 may be desirable in combination with a relatively nonrigid window covering 12, whereas a smaller guide 20 may be suitable for a relatively rigid window covering 12 (e.g., equipped with the stiffener assembly 26).

The base 18 is preferably configured to be securely attached to the frame 30 of a window, for example, with screws. FIGS. 1 through 4 represent the motor 14 as being optionally clamped to the base 18 with a C-clamp 28. In addition to accommodating the motor 14, the base 18 preferably has compartments for batteries or other energy storage devices, and optionally for solar panels for charging the batteries to enable the system to be self-sustaining. Alternatively or in addition, the motor 14 may be powered by an external power source, such as the electrical circuitry of the building in which the system is installed. The base 18 and/or guide 20 may also be configured to accommodate the window covering 12 equipped with the stiffener assembly 26, such as slots that act as vertical guides for the stiffener assembly 26.

FIG. 13 depicts data collected between sunrise and sunset from a window covering 12 on a window having a 180-degree arch with light intensity as a priority over temperature. In FIG. 13, sunrise and sunset are shown as icons on the x-axis. The angle of the window covering 12 was maintained until around 11:00 a.m., and then changed to 180 degrees, i.e., the closed position. The window was then fully exposed by fully stowing the covering 12 (an angle of zero degrees) around 6:00 p.m. when the light intensity was less than the set light intensity maximum value represented by an arrow in FIG. 13. During the day, the change in temperature was minimal. However, the change in light intensity was higher. During this scenario, preferring light intensity over temperature resulted in the system operating more efficiently.

As previously noted above, though the foregoing detailed description describes certain aspects of one or more particular embodiments of the invention, alternatives could be adopted by one skilled in the art. For example, the window unit 10 and its components could differ in appearance and construction from the embodiments described herein and shown in the drawings, functions of certain components of the window unit 10 could be performed by components of different construction but capable of a similar (though not necessarily equivalent) function, process parameters such as temperatures and durations could be modified, and various materials could be used in the fabrication of the window unit 10 and/or its components. As such, and again as was previously noted, it should be understood that the invention is not necessarily limited to any particular embodiment described herein or illustrated in the drawings.

1. An automated system for controlling an extent to which at least a first window is covered based on temperatures and/or light intensities at the first window, the system comprising a window unit comprising:
a window covering sized and configured to at least partially cover the first window when the window covering is in a deployed configuration thereof and expose the first window when the window covering is in a stowed configuration thereof;
a base mountable to a frame of the first window;
a motor supported on the base;
an arm assembly associated with the motor and connected to the window covering so that the motor is operable to rotate the window covering; and
a base guide mounted to the base, the base guide being configured to guide the movement of the window covering as the window covering rotates between the deployed and stowed configurations thereof.

2. The automated system of claim 1, wherein the window covering has at least one radial support member along a radial edge thereof that is adapted to be attached to at least one arm of the arm assembly.

3. The automated system of claim 2, wherein the window covering has a second radial edge that is opposite the radial support member and configured to be secured to the frame of the first window.

4. The automated system of claim 1, wherein the window unit further comprises:
a perimeter support; and
guide clips attached to an edge of the window covering and slidably coupled to the perimeter support to support the window covering as the window covering is rotated between the deployed and stowed configurations thereof.

5. The automated system of claim 4, wherein the window is a curved window having an arch and the perimeter support is an arch support mounted along the arch of the window.

6. The automated system of claim 1, wherein the window unit further comprises a stiffening assembly comprising:
radial members extending from the base guide and coupled to the window covering; and
interconnecting members interconnecting the radial members, the interconnecting members being collapsible under compression.

7. The automated system of claim 1, wherein the window covering is rotatable between the deployed and stowed configurations thereof based on user settings.

8. The automated system of claim 7, further comprising at least one user interface device for manually inputting the user settings into the system.

9. The automated system of claim 7, wherein the at least one user interface device comprises a wireless remote.

10. The automated system of claim 7, wherein the user settings include environmental conditions at the first window, the environmental conditions including at least one of temperature and light intensity.

11. The automated system of claim 7, further comprising a server operating in an intranet and a microprocessor connected to the server, the microprocessor operable to control rotation of the window covering between the deployed and stowed configurations thereof.

12. The automated system of claim 11, wherein the microprocessor is operable to automatically control rotation of the window covering between the deployed and stowed configurations thereof based on environmental conditions at the first window, the environmental conditions including at least one of temperature and light intensity.

13. The automated system of claim 12, wherein the environmental conditions further include local sunrise and sunset.

14. The automated system of claim 1, wherein the window is a curved window and the window covering is sized and configured to at least partially cover the curved window.

15. The automated system of claim 1, wherein the window unit further comprises a position sensor for detecting the stowed configuration of the window covering.

16. The automated system of claim 1, wherein the base guide comprises two flanges between which the window covering rotates as the window covering rotates between the deployed and stowed configurations thereof.

17. The automated system of claim 1, wherein the base guide is a first base guide that is detachable from the base, the automated system further comprising a second base guide that is larger or smaller than the first base guide and interchangeable with the first base guide.

18. A method of using the automated system of claim 1, the method comprising initializing the system with user settings including environmental conditions at the first window, the environmental conditions including at least one of temperature and light intensity.

19. The method of claim 18, further comprising detecting a zero angle of the window covering in the stowed configuration thereof as a reference to position the window covering at desired angles between the stowed and deployed configurations.

20. The method of claim 18, further comprising:
automatically controlling rotation of the window covering based on environmental conditions at the first window, the environmental conditions including at least one of temperature, light intensity, and local sunrise and sunset; and
manually overriding automatic control of the rotation of the window covering with manual user settings.
